(19) United States
(12) Patent Application Publication
(10) Pub. No.: US 2015/0278953 A1
(43) Pub. Date: Oct. 1, 2015

(54) IDENTIFYING ELIGIBILITY BASED INVESTMENT OPTIONS

(71) Applicant: Bank of America Corporation, Charlotte, NC (US)

(72) Inventor: Arvind Srinivasan Ramakrishnan, West Windsor, NJ (US)

(73) Assignee: Bank of America Corporation, Charlotte, NC (US)

(21) Appl. No.: 14/224,834

(22) Filed: Mar. 25, 2014

(51) Int. Cl. G06Q 40/06

(52) U.S. Cl. CPC G06Q 40/06

(57) ABSTRACT

Methods, systems, computer-readable media, and apparatuses for presenting eligibility based investment options to a financial advisor are presented. In some embodiments, a computing device may authenticate a financial advisor. Subsequently, the computing device may determine an eligibility level of the financial advisor based on the authentication of the financial advisor. The computing device may then provide a client list and receive a selection of one or more clients from the client list. Subsequently, the computing device may present one or more options to the financial advisor based on the determined eligibility level.

### BACKGROUND

Aspects of the disclosure relate to computer hardware and software. In particular, one or more aspects of the disclosure generally relate to computer hardware and software for determining the eligibility level of a financial advisor and presenting one or more options to the financial advisor based on that eligibility level.

Financial institutions often provide various investment products and/or services, which may be offered to individuals (e.g., clients, potential clients, and the like) by financial advisors. Generally, financial advisors have completed a minimum level of training and/or coursework regarding the management of investment options, as well as being licensed at some level to perform the management of investment options. The financial institutions that provide the investment options may place restrictions on which investment products and/or services may be available to individual financial advisors. For example, investment products and/or services may have varying levels of risk associated with each investment option. The financial institution may seek to control the risk of the different investment options by limiting the accessibility of the higher risk investments to those financial advisors who have a higher level of experience (which may include, e.g., high-level training, high-level licensing, and the like). Occasionally the investment products and/or services may have conflicting qualifications for accessibility by a financial advisor (e.g., the level of experience required may vary by investment option). Such conflicting qualifications may make it difficult for a financial institution to identify whether a financial advisor is qualified to offer specific investment options to their clients.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, and convenient ways of presenting eligibility based investment options to a financial advisor. In particular, certain aspects of the disclosure provide techniques for determining the eligibility level of the financial advisor and presenting one or more options to the financial advisor based on that eligibility level.

For example, some aspects of the disclosure provide ways of authenticating a financial advisor, as well as determining an eligibility level of the financial advisor based on the authentication of that financial advisor. Subsequently, a strategy builder tool will provide a client list and will receive a selection of one or more clients from that client list. The computing device will then present one or more options to the financial advisor based on the determined eligibility level.

By providing a strategy builder tool for presenting one or more options to a financial advisor based on that financial advisor's determined eligibility level in accordance with one or more aspects of the disclosure, an organization may more efficiently identify the qualifications of a financial advisor and better manage the risk associated with investment options offered by financial advisors. For instance, by having a strategy builder tool identify a financial advisor's qualifications, as discussed below, an organization may better identify the experience or eligibility level of that financial advisor making it easier to identify the types of products that financial advisor is qualified to offer.

Thus, in some embodiments discussed below, a strategy builder tool (which may, e.g., be provided by one or more computing devices) may determine a financial advisor's eligibility. The eligibility of the financial advisor may be assessed and determined by considering data from a variety of sources, including licensing qualifications, educational qualifications, security qualifications and/or experience qualifications. Subsequently, one or more options may be presented to the financial advisor based on the determined eligibility level of the financial advisor (e.g., the financial advisor's eligibility level may correspond or correlate to the types of products and/or services that the financial advisor may offer to their clients). For example, a financial advisor having extensive training and experience may have the authority to make changes to trading, strategy and asset allocation for their clients, and may have an extensive number of investment options available for offering to those clients. In contrast, a financial advisor having only the minimum or basic levels of training and experience may have the authority to make changes only to strategy and asset allocation for their clients, and may have a limited number of investment options to offer to clients. In certain instances, the one or more options presented to the financial advisor may also be based on the one or more clients selected by the financial advisor. The options selected by the financial advisor may be received by the strategy builder tool.

In some instances, the financial advisor's eligibility may be determined based on the authentication of a user account for the financial advisor. The user account to be authenticated may be created as a new account or may be an existing account that is accessed. The strategy builder tool may, in some instances, present information to the financial advisor on how to increase their eligibility level (which may include e.g., recommended additional coursework, training, licensing, and the like).

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for presenting eligibility based investment options to a financial advisor according to one or more embodiments;

FIG. 3 illustrates a flowchart that depicts a method of presenting eligibility based investment options to a financial advisor according to one or more embodiments;

FIG. 4 illustrates a table that depicts qualifications and training identified for different financial advisor eligibility levels according to one or more embodiments; and

FIG. 5 illustrates a table that depicts levels of authority for different financial advisor eligibility levels according to one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

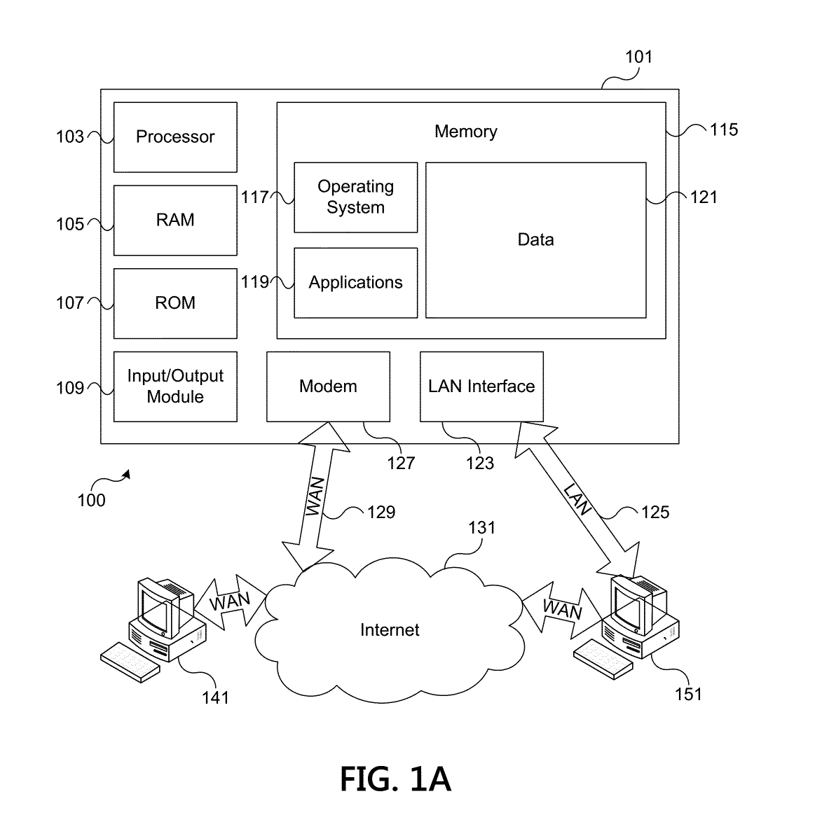

As noted above, certain embodiments are discussed herein that relate to determining the eligibility level of a financial advisor and presenting one or more options to the financial advisor based on that eligibility level. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to determining the eligibility level of the financial advisor and presenting one or more options to the financial advisor based on that eligibility level. In the discussion below, various examples illustrating how eligibility based investment options may be presented to a financial advisor using a strategy builder tool in accordance with one or more embodiments will be provided.

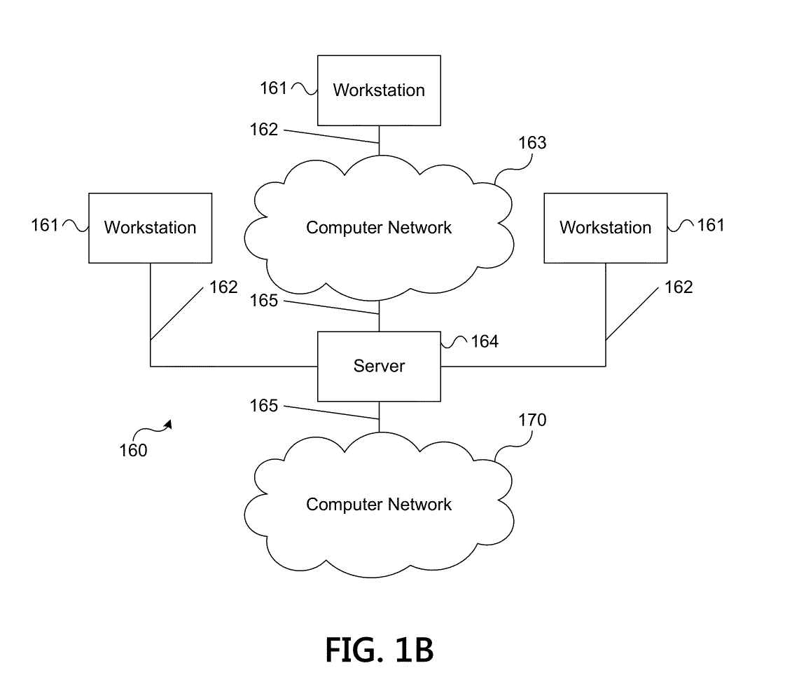

FIG. 2 illustrates an example of a system 200 for presenting options to a financial advisor based on the financial advisor's eligibility level according to one or more embodiments. In some embodiments, system 200 and/or its sub-elements, such as strategy builder tool 205, may be implemented in one or more computing devices, which may include and/or incorporate one or more processors, one or more memories, and/or one or more aspects of the computing device 101 discussed above. In some instances, system 200 may include a number of different subsystems, databases, and/or libraries. In some arrangements, all of the databases included in system 200 may be included in and/or incorporated into a single computing device, while in other arrangements, each database included in system 200 (and/or combinations thereof) may be included in and/or incorporated into a distinct and/or dedicated computing device.

As shown in FIG. 2, in some embodiments, investment portfolio construction system 200 may include a strategy builder tool 205. Strategy builder tool 205 may be configured to receive various types of information from upstream feeds 210. Strategy builder tool 205 may be configured to send and/or exchange various types of information with one or more other devices, which may include contributing information to downstream feeds 215. Additionally, strategy builder tool 205 may be configured to include multiple input interactions 220 and multiple output interactions 225. Strategy builder tool 205 may generate one or more user interfaces 230 to be accessed by one or more users. This arrangement represents one example configuration of system 200. In other embodiments, one or more elements of system 200 may be combined and/or additional and/or alternative types of information and/or requests may be included and/or handled in addition to and/or instead of those shown in FIG. 2.

In some embodiments, strategy builder tool 205 may be configured to collect and process information. In one or more arrangements, the information and/or data that is collected and/or processed by strategy builder tool 205 may include information from one or more upstream feeds 210. The information obtained from upstream feeds 210 may include information regarding assets and production costs, pool membership, producer and registrations, client or financial advisor information, education, instances of heightened supervision, sales practice complaints, user hierarchy and the like. In some instances, the information may be received from one or more databases. The information obtained from upstream feeds 210 may be utilized by strategy builder tool 205 to identify the eligibility level of a financial advisor. For example, information regarding a financial advisor's education qualifications, experience qualifications, licensing qualifications, security qualifications, and the like, may be measured to determine the financial advisor's eligibility level.

Strategy builder tool 205 may also be configured to collect and process information and data from upstream feeds 210 and to transmit the collected and processed information to downstream feeds 215. In some instances, downstream feeds 215 may include information and/or data regarding producer certification, securities (which may include, e.g., 3-rated securities, and the like), authorized producers, and the like. Downstream feeds 215 may include information located in one or more databases. In some instances, strategy builder tool 205 may determine the eligibility level of a financial advisor and may contribute that information to downstream feeds 215.

In some embodiments, strategy builder tool 205 may also include one or more input interactions 220. Information and/or data obtained from input interactions 220 may include information regarding advisory services (which may include, e.g., ADV-2B information, and the like), accounts (which may include, e.g., an account revocation tool, and the like), billing, supervision, portfolio access information (which may include, e.g., a portfolio access tool, and the like), securities (which may include, e.g., security master database (SMDB) information, and the like), and the like. Input interactions 220 information may be received by strategy builder tool 205 from one or more databases. In some instances, the information obtained from input interactions 220 may be utilized by strategy builder tool 205 to identify and determine the eligibility level of a financial advisor.

In some embodiments, strategy builder tool 205 may include one or more output interactions 225. The information and/or data included in output interactions 225 may include information regarding client and user access portals (which may include, e.g., a control panel, and the like), education, enrollment, providers, investment options (which may include, e.g., IProp/ISQ information, and the like), financial advisor supervision, quarterly performance reviews (QPR), and the like. Output interactions may be transmitted by strategy builder tool 205 to one or more databases. In some instances, the strategy builder tool 205 may determine the eligibility level of a financial advisor and may contribute that information to output interactions 225.

In some instances, strategy builder tool 205 may be further configured to produce and/or generate one or more user interfaces 230. User interfaces may provide information regarding a variety of subjects including, for example, financial advisor information (which may include, e.g., user account profile information, eligibility information, certification information, and the like), investment options (which may include, e.g., pool information, and the like), securities (which may include, e.g., 3-rated securities information, and the like), advisory information (which may include, e.g., ADV-2B search information, and the like), transitions, approvals, and the like. The user interfaces may be accessed by one or more users (e.g., a financial advisor, head office (HO) user, operations management team (OMT), and the like). In some instances, the one or more user interfaces accessible by a user may be dependent on the eligibility level of the user (e.g., a user with a first level of eligibility may only access a first user interface, a user with a second level of eligibility may access a first and second user interface, a user with a third level of eligibility may access a first, second and third user interface, and the like). For example, a user may access user interfaces entitled Advisor Info, Certification, Pool, 3Rated, CPR, Adv-2B Search, Transition and/or Approvals. In some instances, a financial advisor may access interfaces entitled Advisor Info, Certification, Pool, 3Rated, CPR and Adv-2B; an HO user may access interfaces entitled Advisor Info, Certification, Pool, 3Rated, CPR, Adv-2B Search and Transition; and an OMT user may access an Approvals interface.

As indicated above, these are examples of the elements that may be included in system 200 in some embodiments, as well as some of the functions that may be performed (e.g., by system 200). In other embodiments, additional and/or other elements may similarly be included and/or other functions may be performed, in addition to and/or instead of those discussed above.

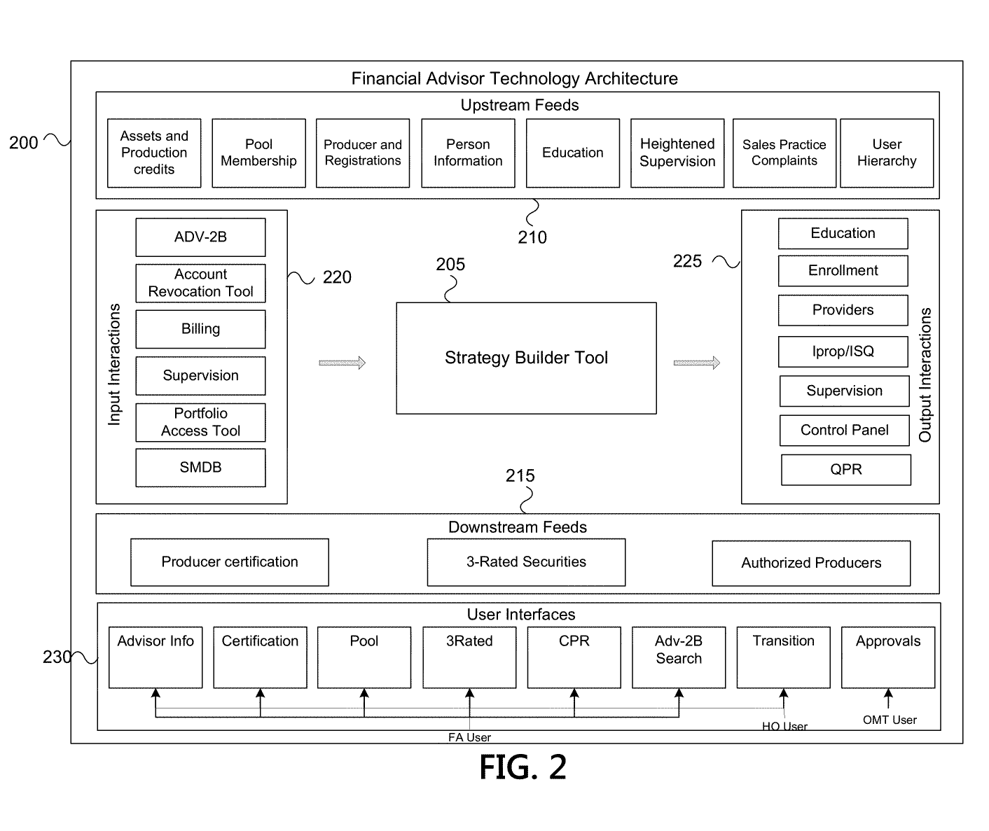

Having described an example system that may be used in presenting options to a financial advisor based on the financial advisor's eligibility level in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of authenticating a user account of a financial advisor, as well as determining an eligibility level of the financial advisor based on the authentication of the user account according to one or more embodiments. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which a new user account may be created and accessed (step 305a) or an existing user account may be accessed (step 305b). For example, in step 305a, a computing device (e.g., computing device 101, system 200, and/or the like) may create a new user account for a financial advisor and then access that account. Alternatively, in step 305b, a computing device may access a financial advisor's previously created user account. In some instances, a financial advisor may create a new user account for accessing an investment portfolio construction system. In other instances, the financial advisor may have an existing user account that may be utilized for accessing the investment portfolio construction system. A user account may be accessed by utilizing a user name and password. The user account may include information regarding the financial advisor, such as name, financial position, location, and the like.

In step 310, the financial advisor may be authenticated. For example, in step 310, the computing device may authenticate the financial advisor associated with the account accessed in step 305. A financial advisor may be authenticated when a computing device accesses one or more databases to determine that the financial advisor has at least a minimum first level of eligibility (e.g., is at least a portfolio advisor). In some instances, during authentication of the financial advisor, the computing device may access information regarding the financial advisor including licensing qualifications, educational qualifications, security qualifications and experience qualifications. The computing device may also identify additional or alternative user accounts associated with the financial advisor. For example, the computing device may access information for one or more user accounts associated with the financial advisor (which may include, e.g., identifying any discrepancies in the qualifications of the financial advisor).

In step 315, an eligibility level of the financial advisor may be determined. For example, in step 315, the computing device may determine an eligibility or qualification level of the financial advisor based on the authentication of the user account in step 310. The eligibility level of the financial advisor may be designated as, for example, a first level, a second level, a third level, and a fourth level. More or fewer levels may be considered without departing from the invention. In some instances, a first level financial advisor may be a portfolio advisor (e.g., a relationship seller who offers prepackaged investment options and the like). A second level financial advisor may be a senior portfolio advisor (e.g., an individual who may make minor adjustments to asset allocation, but stays within certain investment vehicles). A third level financial advisor may be a portfolio manager (e.g., an individual who may build their own equity models and develop personal strategies for clients). A fourth level financial advisor may be a senior portfolio manager (e.g., a money manager who may create strategies for multiple clients across a book of business).

In some instances, the eligibility level of the financial advisor of step 315 may be determined based on one or more of licensing qualifications (which may include, e.g., information on the professional license(s) obtained by a financial advisor, and the like), educational qualifications (which may include, e.g., information regarding coursework and/or trainings completed by the financial advisor, and the like), security qualifications (which may include, e.g., terms of service, length of service, and the like), experience qualifications (which may include, e.g., amount of time under management, previous portfolio management experience, managing investments of a large monetary value, client complaints, and the like). Each eligibility level may have a minimum threshold that must be reached of one or more of these various qualifications. In some instances, for a financial advisor to be determined to have a specific eligibility level (e.g., first, second, third, and the like), that financial advisor must have completed and/or obtained the minimum threshold for one or more of coursework qualifications, licensing qualifications, experience qualifications, and security qualifications for that eligibility level. The qualification information for a financial advisor may be accessed and/or obtained from one or more databases.

In step 320, a client list may be provided. For example, in step 320, the computing device may provide a client list to the financial advisor. The client list may include potential, current and/or past clients of the financial advisor. In some instances, the clients in the client list may be classified by the investment products and/or services associated with each client. For example, clients that have a large and/or complicated investment portfolio may be grouped together, while clients having a small and/or non-complicated investment portfolio may be grouped together.

In step 325, one or more clients may be selected from the client list. For example, in step 325, the computing device may receive a selection of one or more clients from the client list provided in step 320. In some instances, once a client is selected from a client list, information regarding that client will be readily available, including information regarding any assets available for that client, as well as past or current investment options associated with that client.

In step 330, one or more options may be presented to the financial advisor. For example, in step 330, the computing device may present one or more options to the financial advisor based on the eligibility level determined in step 315. In some instances, investment options may be available for financial advisors who have a specific eligibility level (e.g., a first, second, third or fourth eligibility level). After a financial advisor's eligibility level has been determined, the computing device may present the financial advisor with a list of investment options that are available to be accessed by the financial advisor. For example, a financial advisor who has a low eligibility level (e.g., is a portfolio advisor) will only be offered preapproved investment packages and will have no ability to modify those packages. In contrast, a financial advisor with a determined high eligibility level (e.g., is a senior portfolio manager) will be able to create strategies for multiple clients and will have the flexibility to make changes to trading, strategy and asset allocation. In some instances, the limitation in the options available to the financial advisor lowers the risk of the financial institution providing those options because less experienced financial advisors will be unable to access high risk investment options (e.g., financial advisors with level one eligibility only have access to low risk investment options).

In some instances, the presentation of one or more options by the computing device of step 330 may be further based on the one or more clients selected in step 325. For example, the one or more investment options presented to the financial advisor may be based on both the determined eligibility level of the financial advisor of step 215, as well as on various characteristics of the client selected from the client list of step 325. In some instances, the selection of the client may limit the options available to the financial advisor because of the investment options already utilized by the client. Additionally or alternatively, the investment options presented may be determined based on the sophistication of the client (e.g., a sophisticated client requires a large number of investment options).

In some arrangements, the number of investment options may be based on the determined eligibility level of the financial advisor, and in some instances on the client selected from the client list. In some instances, a computing device may present more options to a financial advisor with a level four eligibility level than to a financial advisor with a level one eligibility level. For example, a financial advisor with a level four eligibility level may be presented with all available options for a selected client. In contrast, a financial advisor with a level one eligibility level may be presented with fewer options for the same selected client. Additionally or alternatively, a financial advisor with a level four eligibility level may be presented with a client list that includes all available clients, while a financial advisor with a lower eligibility level (e.g., level one, two or three) may be presented with a client list having a limited number of clients. The client list and the options available to the financial advisor may both be dependent on the eligibility level of the financial advisor.

Optionally, in step 335, options may be selected from the one or more options presented. For example, in step 335, the computing device may receive a selection of investment options from the one or more options presented to the financial advisor in step 330. In some instances, a financial advisor may present one or more investment options to a client and, based on the client instructions, will select investment options from the one or more options based on the client request. Alternatively, a financial advisor may select investment options on behalf of a client from the one or more options presented. The options selected by the financial advisor may be transmitted to and received by the computing device. In some instances, the computing device may collect and/or aggregate the selected options. The selected options information may be used to monitor the financial advisor's performance, monitor the changes to the clients options information, and the like. In some instances, the computing device may provide the selected options to one or more system(s) for processing the identified options.

Optionally, in step 340, information for increasing a financial advisor's eligibility level may be presented. For example, in step 340, the computing device may present information to the financial advisor as to how to increase their eligibility level. The financial advisor's eligibility level may be increased, in some instances, by completing additional training and/or coursework, by recording a certain number of investment hours, by completing additional licensing, and the like. In some instances, the computing device may present the financial advisor with information regarding what actions may be taken to raise the financial advisor's eligibility level.

Subsequently, the method may end. As illustrated in the examples above, however, certain aspects of the presentation of options to a financial advisor based on the financial advisor's eligibility level may be repeated (e.g., in authenticating user accounts, determining eligibility and presenting options to the financial advisor). Additionally or alternatively, the strategy builder tool may perform similar steps as those illustrated in FIG. 3 and discussed above in authenticating a user account of a financial advisor and determining an eligibility level of the financial advisor based on the authentication of the user account.

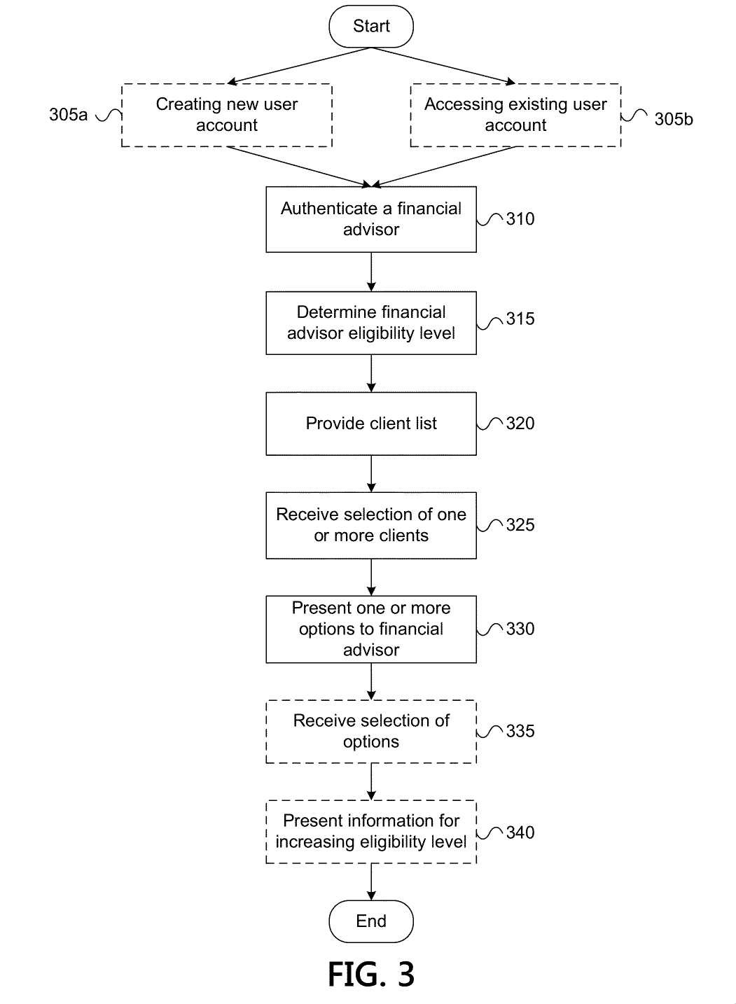

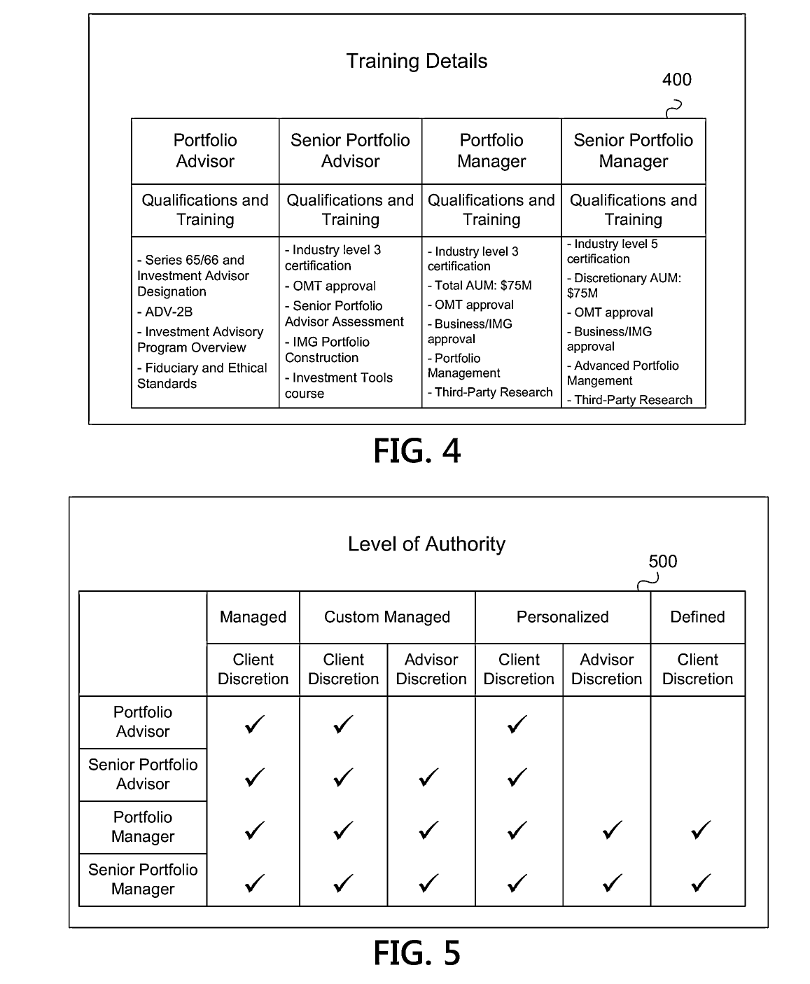

Having described several examples of the processing that may be performed by a computing device in presenting investment options to a financial advisor in some embodiments, examples of the training qualifications for financial advisors and the financial advisor levels of authority will now be discussed with respect to FIGS. 4 and 5.

FIG. 4 illustrates a table 400 that depicts qualifications and training requirements identified for various financial advisor eligibility levels according to one or more embodiments. In some arrangements, table 400 may represent and/or include information that identifies one or more qualification and training options for various financial advisor eligibility levels. For example, table 405 may include information that identifies one or more qualifications or training requirements for obtaining a specific financial advisor eligibility level and what training is required to obtain the next eligibility level.

FIG. 5 illustrates a table 500 that depicts levels of authority for different financial advisor eligibility levels according to one or more embodiments. In some arrangements, table 500 may represent and/or include information that identifies the levels of authority for each eligibility level. In some instances, financial advisors having a level of discretion in custom and managed strategy may make changes to strategy and asset allocation. Additionally, in some instances, financial advisors having an eligibility level that provides for discretion in personalized and defined strategy may make changes to trading, strategy and asset allocations. For example, a senior portfolio advisor, a portfolio manager and a senior portfolio manager may have discretion in custom managed strategy and may make changes to strategy and asset allocations, but only a portfolio manager or a senior portfolio manager may have discretion in personalized and/or defined strategy and may make changes to trading, strategy and asset allocations. In some instances, a client may have the discretion to accept certain changes, even if the financial advisor is not of the required eligibility level.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the figures may be performed in other than the recited order, and one or more steps illustrated may be optional in accordance with aspects of the disclosure.

What is claimed is:

1. A method comprising:
authenticating, by a strategy builder tool provided by at least one computing device, a financial advisor;
determining, by the strategy builder tool, an eligibility level of the financial advisor based on the authentication of the financial advisor;
providing, by the strategy builder tool, a client list;
receiving, by the strategy builder tool, a selection of one or more clients from the client list; and
presenting, by the strategy builder tool, one or more options to the financial advisor based on the determined eligibility level.

2. The method of claim 1, further comprising:
before authenticating the financial advisor,
creating and accessing, by the strategy builder tool, the user account for the financial advisor, or
accessing, by the strategy builder tool, an existing user account for the financial advisor.

3. The method of claim 1, further comprising:
presenting, by the strategy builder tool, information to the financial advisor for increasing the eligibility level.

4. The method of claim 1, further comprising:
receiving, by the strategy builder tool, a selection of options from the one or more options presented to the financial advisor.

5. The method of claim 1, wherein the presentation of one or more options to the financial advisor is further based on the one or more clients selected.

6. The method of claim 1, wherein determining the eligibility level of the financial advisor is based on licensing qualifications, educational qualifications, security qualifications and experience qualifications.

7. The method of claim 1, wherein a financial advisor with a first eligibility level will be presented with more options than a financial advisor with a second eligibility level.

8. One or more non-transitory computer-readable media having computer-executable instructions stored thereon that, when executed by a strategy builder tool provided by at least one computing device, cause the strategy builder tool to:
authenticate a financial advisor;
determine an eligibility level of the financial advisor based on the authentication of the financial advisor;
provide a client list;
receive a selection of one or more clients from the client list; and
present one or more options to the financial advisor based on the determined eligibility level.

9. The one or more non-transitory computer readable media of claim 8, having additional computer-executable instructions stored thereon that, when executed by the strategy builder tool, further cause the strategy builder tool to:
before authenticating the financial advisor,
create and access the user account for the financial advisor, or
access an existing user account for the financial advisor.

10. The one or more non-transitory computer readable media of claim 8, having additional computer-executable instructions stored thereon that, when executed by the strategy builder tool, further cause the strategy builder tool to:
present information to the financial advisor for increasing the eligibility level.

11. The one or more non-transitory computer readable media of claim 8, having additional computer-executable instructions stored thereon that, when executed by the strategy builder tool, further cause the strategy builder tool to:
receive a selection of options from the one or more options presented to the financial advisor.

12. The one or more non-transitory computer readable media of claim 8, wherein the presentation of one or more options to the financial advisor is further based on the one or more clients selected.

13. The one or more non-transitory computer readable media of claim 8, wherein determining the eligibility level of the financial advisor is based on licensing qualifications, educational qualifications, security qualifications and experience qualifications.

14. The one or more non-transitory computer readable media of claim 8, wherein a financial advisor with a first eligibility level will be presented with more options than a financial advisor with a second eligibility level.

15. A computing device, comprising:
at least one processor; and
memory storing computer readable instructions that, when executed by the at least one processor, cause a strategy builder tool provided by the computing device to:
authenticate a financial advisor;
determine an eligibility level of the financial advisor based on the authentication of the financial advisor;
provide a client list;
receive a selection of one or more clients from the client list; and
present one or more options to the financial advisor based on the determined eligibility level.

16. The computing device of claim 15, wherein the memory stores additional computer readable instructions that, when executed by the at least one processor, further cause the strategy builder tool to:
before authenticating the financial advisor,
create and access the user account for the financial advisor, or
access an existing user account for the financial advisor.

17. The computing device of claim 15, wherein the memory stores additional computer readable instructions that, when executed by the at least one processor, further cause the strategy builder tool to:
present information to the financial advisor for increasing the eligibility level.

18. The computing device of claim 15, wherein the memory stores additional computer readable instructions that, when executed by the at least one processor, further cause the strategy builder tool to:
receive a selection of options from the one or more options presented to the financial advisor.

19. The computing device of claim 15, wherein the presentation of one or more options to the financial advisor is further based on the one or more clients selected.

20. The computing device of claim 15, wherein determining the eligibility level of the financial advisor is based on licensing qualifications, educational qualifications, security qualifications and experience qualifications.

21. The computing device of claim 15, wherein a financial advisor with a first eligibility level will be presented with more options than a financial advisor with a second eligibility level.
